(19) United States
(12) Patent Application Publication
(10) Pub. No.: US 2025/0216348 A1
(43) Pub. Date: Jul. 3, 2025

(54) X-RAY PHOTOELECTRON SPECTROSCOPY APPARATUS AND METHOD FOR CALCULATING CONCENTRATION OF SPECIFIC ELEMENT IN OBJECT UNDER INSPECTION USING X-RAY PHOTOELECTRON SPECTROSCOPY

(71) Applicant: SAMSUNG ELECTRONICS CO., LTD., Suwon-si (KR)

(72) Inventors: Soobin SINN, Suwon-si (KR); Sungyoon RYU, Suwon-si (KR); Younghoon SOHN, Suwon-si (KR); Ku IM, Suwon-si (KR)

(73) Assignee: SAMSUNG ELECTRONICS CO., LTD., Suwon-si (KR)

(21) Appl. No.: 18/976,948

(22) Filed: Dec. 11, 2024

(30) Foreign Application Priority Data
Dec. 28, 2023 (KR) 10-2023-0194658
Jun. 10, 2024 (KR) 10-2024-0074976

(51) Int. Cl. G01N 23/2273

(52) U.S. Cl. CPC G01N 23/2273

(57) ABSTRACT

Provided is an X-ray photoelectron spectroscopy (XPS) apparatus including a filament configured to emit an electron beam, an anode including metal patterns, an anode actuator configured to move the anode, a stage configured to support an object and a test pad, a capillary configured to emit multicolored X-rays, generated by collision of the electron beam with the anode, onto the object or the test pad, and a detector configured to detect photoelectrons emitted from the object or the test pad emitted by the multicolored X-rays.

### CROSS-REFERENCE TO RELATED APPLICATION

This application claims priority to Korean Patent Application No. 10-2023-0194658 filed on Dec. 28, 2023, and No. 10-2024-0074976 field on Jun. 10, 2024, in the Korean Intellectual Property Office, the disclosure of which is incorporated herein in its entirety by reference.

### BACKGROUND

### 1. Field

Embodiments of the present disclosure relate to an X-ray photoelectron spectroscopy (XPS) apparatus and a method for calculating the concentration of a specific element in an object under inspection using XPS.

### 2. Description of the Related Art

As the complexity of semiconductor processes increases, the importance of semiconductor concentration measurement is also increasing. In particular, there is an emerging need for new concentration measurement techniques with resolution in the depth direction (e.g., vertical direction). As semiconductor processes become finer, advanced ion implantation processes for lightly doped drains (LDDs) or halo implantation regions are essential to control leakage current and ensure operational characteristics. To control such multi-ion implantation processes, it is necessary to measure the ion concentration profile in the vertical direction in addition to measuring the overall ion concentration.

Currently, X-ray photoelectron spectroscopy (XPS) is the highest-resolution concentration measurement technique for use in semiconductor measurement. However, XPS using a single X-ray can only provide the overall concentration information within the entire measurement volume, but not the concentration information in the vertical direction. To obtain depth-direction information using XPS technology, additional measurements are needed, changing the X-ray energy multiple times or changing the detection angle multiple times. This poses a challenge for use in semiconductor manufacturing processes where minimizing measurement time is essential.

Generally, the technology used for vertical direction concentration analysis in semiconductors is secondary ion mass spectroscopy (SIMS). However, SIMS technology has limitations for use in production processes as it involves emitting molecules from samples through strong ion beams, which may destroy the samples.

### SUMMARY

One or more embodiments provide an X-ray photoelectron spectroscopy (XPS) apparatus capable of simultaneously irradiating a test object with multicolored X-rays to measure the concentration of a specific element according to its position in a vertical direction.

Aspects of the present disclosure also provide a method for calculating the concentration of a specific element in an object under inspection using XPS by simultaneously irradiating the object with multicolored X-rays to measure the concentration of the specific element according to its position in a vertical direction.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of one or more embodiments, there is provided an X-ray photoelectron spectroscopy (XPS) apparatus including a filament configured to emit an electron beam, an anode including metal patterns, an anode actuator configured to move the anode, a stage configured to support an object and a test pad, a capillary configured to emit multicolored X-rays, generated by collision of the electron beam with the anode, onto the object or the test pad, and a detector configured to detect photoelectrons emitted from the object or the test pad emitted by the multicolored X-rays.

According to another aspect of one or more embodiments, there is provided an X-ray photoelectron spectroscopy (XPS) apparatus including an X-ray source configured to emit multicolored X-rays and including an anode that includes metal patterns, a stage configured to support an object, a capillary configured to emit the multicolored X-rays onto the object, a detector configured to detect photoelectrons emitted from the object emitted by the multicolored X-rays and generate data, and one or more processors configured to obtain a concentration of an element in a vertical direction within the object based on at least part of the data.

According to still another aspect of one or more embodiments, there is provided a method for calculating the concentration of an element included in an object under inspection using X-ray photoelectron spectroscopy (XPS), including generating X-rays with different energies, emitting X-rays on the object, detecting photoelectrons emitted from the object emitted by the X-rays, and obtaining a concentration of the element in a vertical direction within the object based on the photoelectrons emitted by each of the X-rays . . .

### BRIEF DESCRIPTION OF DRAWINGS

The above and other aspects and features of the present disclosure will become more apparent by describing in detail embodiments thereof with reference to the attached drawings, in which:

FIG. 1 is an exemplary diagram illustrating an X-ray photoelectron spectroscopy (XPS) apparatus according to one or more embodiments;

FIG. 2 is an exemplary flowchart illustrating the operating method of the XPS apparatus according to one or more embodiments;

FIG. 3 is an exemplary flowchart illustrating step S100 of FIG. 2;

FIGS. 4, 5, 6, and 7 are exemplary diagrams illustrating step S100 of FIG. 2;

FIG. 8 is an exemplary flowchart illustrating step S200 of FIG. 2;

FIGS. 9 and 10 are exemplary diagrams illustrating step S200 of FIG. 2;

FIGS. 11, 12, and 13 are exemplary diagrams illustrating the modeling used in step S200 of FIG. 8;

FIG. 14 is an exemplary diagram illustrating the anode of FIG. 1; and

FIG. 15 is an exemplary diagram illustrating the anode of FIG. 1.

### DETAILED DESCRIPTION

Embodiments described herein are example embodiments, and thus, the disclosure is not limited thereto.

It will be understood that, although the terms first, second, third, fourth, etc. may be used herein to describe various elements, components, regions, layers and/or sections (collectively “elements”), these elements should not be limited by these terms. These terms are only used to distinguish one element from another element. Thus, a first element described in this description section may be termed a second element or vice versa in the claim section without departing from the teachings of the disclosure.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

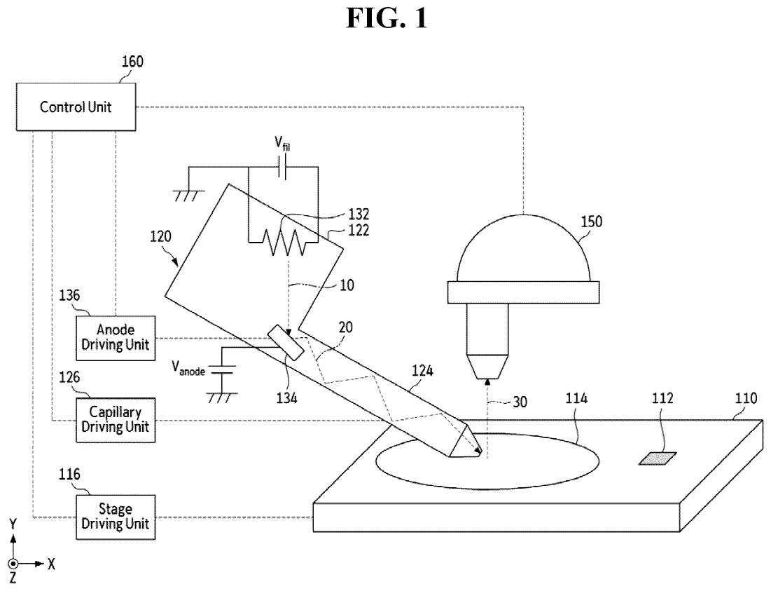

FIG. 1 is an exemplary diagram illustrating an X-ray photoelectron spectroscopy (XPS) apparatus according to one or more embodiments.

Referring to FIG. 1, the X-ray spectroscopy apparatus according to one or more embodiments includes a stage 110, a stage driving unit 116, an X-ray source 120, a capillary driving unit 126, an anode driving unit 136, a detector 150, and a control unit 160.

The stage 110 is configured to support a test pad 112 and an object 114 to be inspected. The test pad 112 and the object 114 may be disposed on the stage 110. Here, a first direction X and the second direction Y may be horizontal relative to the top surface of the stage 110 and may intersect each other. The third direction Z may be perpendicular to the top surface of the stage 110 and may intersect the first and second directions X and Y.

The test pad 112 may be spaced apart from the object 114. The test pad 112 may include a metal such as, for example, gold (Au). The test pad 112 may have, for example, a rectangular shape. However, embodiments are not limited thereto, and the shape, number, and arrangement of the test pad 112 may vary.

The stage driving unit 116 is configured to move the stage 110. The stage driving unit 116 may move the stage 110 in at least one of the first, second, and third directions X, Y, and Z. The stage driving unit 116 may include, for example, actuators such as an electric motor and/or a hydraulic motor.

The X-ray source 120 is configured to emit multicolored X-rays 20.

For example, the X-ray source 120 may include a body 122 and a capillary 124. A filament 132 and an anode 134 may be disposed within the X-ray source 120.

The filament 132 may be configured to emit electron beams 10. The filament 132 may be heated and emit thermoelectrons by being provided with a voltage V_{fil}. The filament 132 may include, for example, tungsten (W).

The electron beams 10 may be emitted onto the anode 134. The thermoelectrons of the electron beams 10 collide with the anode 134 to generate the multicolored X-rays 20. Due to the potential difference between a voltage V_{anode} provided to the anode 134 and the voltage V_{fil} provided to the filament 132, the emission of the thermoelectrons may be accelerated within the X-ray source 120 in its vacuum state.

The capillary 124 is configured to emit the multicolored X-rays 20 onto the test pad 112 or the object 114. The multicolored X-rays 20 may be focused by the capillary 124.

The detector 150 is configured to detect photoelectrons 30 emitted from the test pad 112 or the object 114 emitted by the multicolored X-rays 20. The detector 150 may detect the photoelectrons 30, thus generating data.

The detector 150 may measure the kinetic energy of the photoelectrons 30. For example, the detector 150 may be a hemispherical analyzer.

The capillary driving unit 126 is configured to move the capillary 124. The capillary driving unit 126 may move the capillary 124 in at least one of the first, second, and third directions X, Y, and Z. The capillary driving unit 126 may adjust an angle at which the capillary 124 is tilted with respect to the stage 110. The capillary driving unit 126 may include, for example, actuators such as an electric motor and/or a hydraulic motor.

The anode driving unit 136 is configured to move the anode 134. The anode driving unit 136 may move the anode 134 in at least one of the first, second, and third directions X, Y, and Z. The anode driving unit 136 may adjust an angle at which the anode 134 is tilted with respect to the stage 110. The anode driving unit 136 may include, for example, actuators such as an electric motor and/or a hydraulic motor.

The control unit 160 is configured to control the X-ray spectroscopy apparatus according to one or more embodiments. The control unit 160 may control the stage driving unit 116, the X-ray source 120, the capillary driving unit 126, the anode driving unit 136, and the detector 150. The stage driving unit 116, the capillary driving unit 126, and the anode driving unit 136 may be driven according to control signals from the control unit 160.

The control unit 160 is configured to calculate (obtain) the concentration of a specific element within the object 114 in a vertical direction (or the third direction Z) using at least some of the data generated by the detector 150. The control unit 160 may include a memory for storing information necessary to calculate (obtain) the concentration of the specific element within the object 114 in the vertical direction. The control unit 160 may also receive such information from an external source. The concentration of the specific element within the object 114 in the vertical direction refers to the concentration profile of the specific element according to its position in the vertical direction within the object 114. The concentration of the specific element according to its position in the vertical direction within the object 114 may be expressed as a function of the distance from the top surface of the object 114. That is, the control unit 160 may derive the concentration profile of the specific element as a function of the distance from the top surface of the object 114.

The control unit 160 may be implemented as hardware, firmware, software, or any combination thereof. For example, the control unit 160 may include a computing device such as a workstation computer, desktop computer, laptop computer, or tablet computer. The control unit 160 may also include a complex processor such as a microprocessor, a Central Processing Unit (CPU), or a Graphic Processing Unit (GPU), or a processor configured by software, dedicated hardware, or firmware. The control unit 160 may be implemented by a general-purpose computer or application-specific hardware such as a Digital Signal Processor (DSP), Field Programmable Gate Array (FPGA), or Application-Specific Integrated Circuit (ASIC). For example, the operation of the control unit 160 may be implemented as instructions stored on a machine-readable medium that can be read and executed by one or more processors. Here, the machine-readable medium may include any mechanism for storing and/or transmitting information in a form readable by a machine (e.g., a computing device). For example, the machine-readable medium may include a Read-Only Memory (ROM), Random-Access Memory (RAM), magnetic disk storage medium, optical storage medium, flash memory device, electrical, optical, acoustic, or other forms of propagated signals (e.g., carrier waves, infrared signals, digital signals, etc.), and other media. Alternatively, the control unit 160 may be caused by a computing device, a processor, or another device executing firmware, software, routines, and instructions.

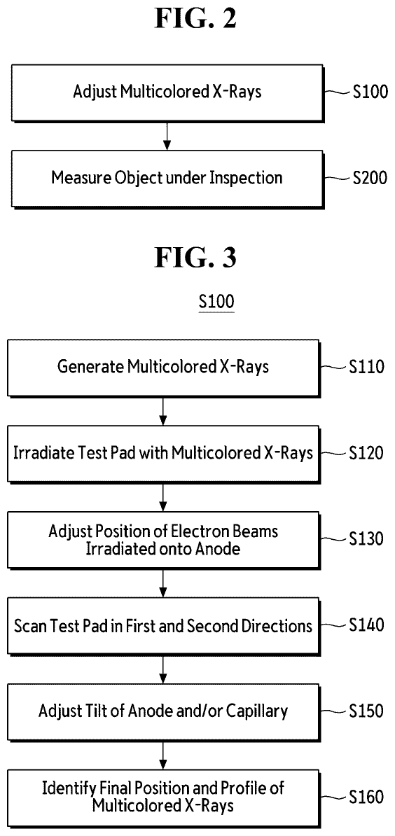

FIG. 2 is an exemplary flowchart illustrating the operating method of the XPS apparatus according to one or more embodiments.

Referring to FIGS. 1 and 2, after adjusting the multicolored X-rays 20 (S100), the object 114 may be measured (S200).

Step S100 may be performed using the test pad 112. In step S100, the stage 110 may be moved by the stage driving unit 116 so that the multicolored X-rays 20 may be emitted onto the test pad 112. Step S100 may be performed periodically. Step S100 may also be performed before every step S200.

In step S200, the stage 110 may be moved by the stage driving unit 116 so that the multicolored X-rays 20 may be emitted onto the object 114.

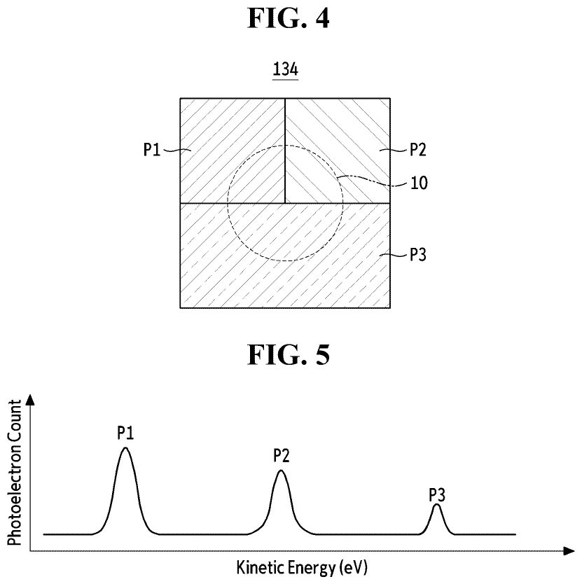

FIG. 3 is an exemplary flowchart illustrating step S100 of FIG. 2. FIGS. 4 through 7 are exemplary diagrams illustrating step S100 of FIG. 2.

Referring to FIGS. 1 and 3, in step S110, the X-ray source 120 may generate the multicolored X-rays 20.

FIG. 4 is an exemplary diagram illustrating the anode 134 of FIG. 1. FIG. 5 shows the photoelectron spectrum emitted from the test pad 112 when the electron beams 10 are emitted onto a plurality of metal patterns including a first metal pattern P1, a second metal pattern P2, and a third metal pattern P3 of FIG. 4, where the X-axis represents the kinetic energy of photoelectrons 30 and the Y-axis represents the number of photoelectrons 30.

Referring to FIG. 4, the anode 134 includes the metal patterns P1, P2, and P3. The number of metal patterns P1, P2, and P3 may vary.

Each of the metal patterns P1, P2, and P3 may include a metal material such as, for example, magnesium (Mg), aluminum (Al), silver (Ag), titanium (Ti), or chromium (Cr). For example, the metal patterns P1, P2, and P3 may include different metal materials.

The relationship between the areas of the metal patterns P1, P2, and P3 may vary. At least two of the metal patterns P1, P2, and P3 may have the same area or different areas.

For example, the area and/or position of each of the metal patterns P1, P2, and P3 may be determined based on the number of photoelectrons 30 generated from the corresponding metal pattern among the metal patterns P1, P2, and P3. Referring to FIG. 5, the number of photoelectrons 30 generated from the collision of the test pad 112 and X-rays generated by the electron beams 10 colliding with a third metal pattern P3 may be less than the number of photoelectrons 30 generated from the collision of the test pad 112 and X-rays generated by the electron beams 10 colliding with a first metal pattern P1 and the number of photoelectrons 30 generated from the collision of the test pad 112 and X-rays generated by the electron beams 10 colliding with a second metal pattern P2. Therefore, the area of the third metal pattern P3 may be larger than the areas of the first and second metal patterns P1 and P2.

The shape of each of the metal patterns P1, P2, and P3 may vary. From a planar perspective including the first and second directions X and Y, each of the metal patterns P1, P2, and P3 may have various shapes such as a rectangular shape or a circular shape. From a planar perspective including the first and second directions X and Y, at least two of the metal patterns P1, P2, and P3 may have the same shape or different shapes.

The electron beams 10 may be emitted onto the metal patterns P1, P2, and P3. The thermoelectrons of the electron beams 10 may collide with each of the metal patterns P1, P2, and P3 to generate X-rays of different energies for different metal patterns P1, P2, and P3, for example, the multicolored X-rays 20. For example, the electron beams 10 may be emitted simultaneously onto the metal patterns P1, P2, and P3, and the multicolored X-rays 20 may be generated simultaneously.

For example, the X-rays generated from the first metal pattern P1 may have a different energy than the X-rays generated from the second and third metal patterns P2 and P3, and the multicolored X-rays 20 may include the X-rays generated from the metal patterns P1, P2, and P3.

Referring again to FIGS. 1 and 3, in step S120, the multicolored X-rays 20 may be emitted onto the test pad 112.

The stage driving unit 116 may move the stage 110 so that the multicolored X-rays 20 may be emitted onto the test pad 112, under the control of the control unit 160.

The multicolored X-rays 20 may be focused by the capillary 124 and emitted onto the test pad 112. The capillary driving unit 126 may move the capillary 124 close to the test pad 112 (but not to be in contact with the test pad 112) under the control of the control unit 160.

In step S130, the position of the electron beams 10 emitted onto the anode 134 may be adjusted so that the number of photoelectrons 30 generated from each of the metal patterns P1, P2, and P3 may become uniform.

Referring to FIGS. 4 and 5, the number of photoelectrons 30 generated from the collision of the test pad 112 and X-rays generated by the electron beams 10 colliding with the first metal pattern P1, the number of photoelectrons 30 generated from the collision of the test pad 112 and X-rays generated by the electron beams 10 colliding with the second metal pattern P2, and the number of photoelectrons 30 generated from the collision of the test pad 112 and X-rays generated by the electron beams 10 colliding with the third metal pattern P3 may all differ from one another.

For example, the control unit 160 may determine which peaks in FIG. 5 correspond to which metal patterns P1, P2, and P3 based on the kinetic energy values of the metal patterns P1, P2, and P3. The control unit 160 may store the kinetic energy values for the metal patterns P1, P2, and P3 internally or may receive them from an external source.

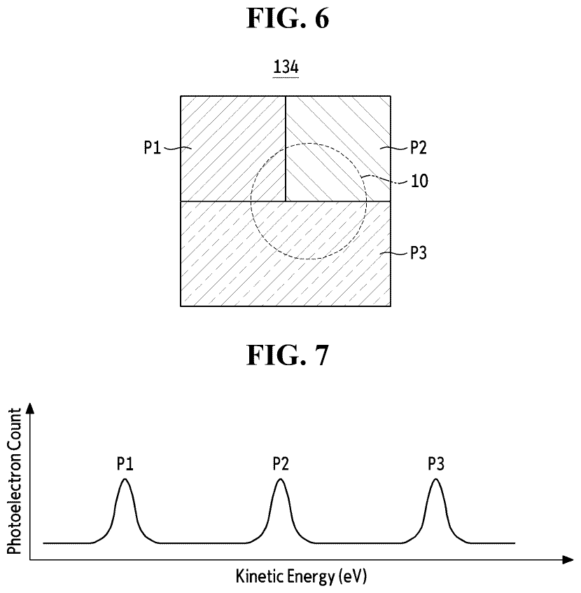

FIG. 7 shows the photoelectron spectrum emitted from the test pad 112 when the electron beams 10 are emitted onto each of the metal patterns P1, P2, and P3 as shown in FIG. 6, where the X-axis represents the kinetic energy of photoelectrons 30 and the Y-axis represents the number of photoelectrons 30.

Referring to FIGS. 4 through 7, in step S130, the number of photoelectrons generated from the collision of the test pad 112 and the X-rays generated by the electron beams 10 colliding with the first metal pattern P1, the number of photoelectrons generated from the collision of the test pad 112 and the X-rays generated by the electron beams 10 colliding with the second metal pattern P2, and the number of photoelectrons generated from the collision of the test pad 112 and the X-rays generated by the electron beams 10 colliding with the third metal pattern P3 may be adjusted to be uniform (or identical) by adjusting the position of the electron beams 10 emitted onto the anode 134.

For example, the anode driving unit 136 may change the position of the anode 134 in the first and second directions X and Y under the control of the control unit 160. The detector 150 may generate data by detecting the number of photoelectrons 30 generated from each of the metal patterns P1, P2, and P3 based on the position of the anode 134 in the first and second directions X and Y. Based on the generated data, the control unit 160 may determine the position of the anode 134 in the first and second directions X and Y that results in a uniform number of photoelectrons 30 generated from each of the metal patterns P1, P2, and P3. The anode driving unit 136 may position the anode 134 at the determined position in the first and second directions X and Y under the control of the control unit 160.

Referring again to FIGS. 1, 3, and 6, in step S140, the test pad 112 may be scanned in the first and second directions X and Y. At this time, the position of the anode 134 in the first and second directions X and Y may be the position determined in step S130.

For example, the stage driving unit 116 may change the position of the test pad 112 in the first and second directions X and Y under the control of the control unit 160. The detector 150 may generate data by detecting the X-rays emitted from each of the metal patterns P1, P2, and P3 based on the position of the test pad 112 in the first and second directions X and Y. Based on the data, the control unit 160 may determine the beam position and profile of the X-rays emitted from each of the metal patterns P1, P2, and P3 and provided to the test pad 112.

In step S150, based on the result of scanning the test pad 112 in the first and second directions X and Y, an angle at which at least one of the anode 134 and the capillary 124 is tilted relative to the stage 110 may be adjusted.

For example, based on the data generated in step S140, the control unit 160 may determine the angle at which at least one of the anode 134 and the capillary 124 is tilted relative to the stage 110. The anode driving unit 136 may adjust the angle at which the anode 134 is tilted to the determined angle under the control of the control unit 160. The capillary driving unit 126 may adjust the angle at which the capillary 124 is tilted to the determined angle under the control of the control unit 160.

For example, the control unit 160 may determine the angle at which at least one of the anode 134 and the capillary 124 is tilted so that the beam position and profile of the X-rays emitted from each of the metal patterns P1, P2, and P3 and provided to the test pad 112 may become uniform.

For example, the control unit 160 may determine the beam position and profile of the X-rays provided to the object 114 based on the measurement objective of the object 114. The control unit 160 may control the angle at which at least one of the anode 134 and the capillary 124 is tilted so that the X-rays emitted from each of the metal patterns P1, P2, and P3 and provided to the test pad 112 may have the determined beam position and profile.

In step S160, the position and profile of the multicolored X-rays 20 may be finally identified. The position of the anode 134 in the first and second directions X and Y may be the position determined in step S130. The angle at which the anode 134 and/or the capillary 124 is tilted may be the angle determined in step S150.

A determination may be made as to whether the beam position and profile of the X-rays emitted from each of the metal patterns P1, P2, and P3 of the anode 134 match the beam position and profile determined in step S150.

For example, when the beam position and profile of the X-rays emitted from each of the metal patterns P1, P2, and P3 of the anode 134 do not match the beam position and profile determined in step S150, step S150 may be repeated to readjust the angle at which at least one of the anode 134 and the capillary 124 is tilted.

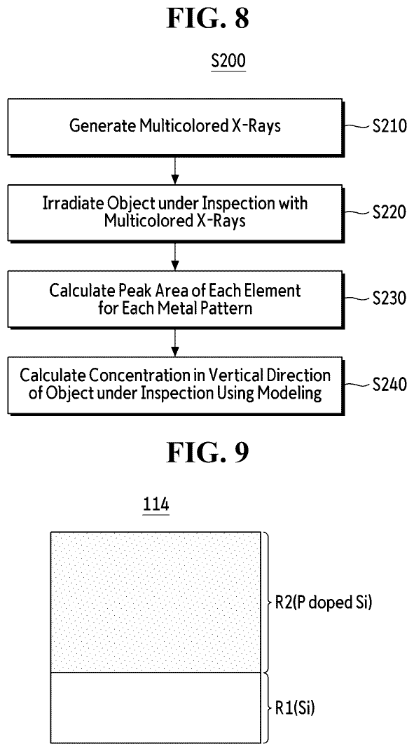

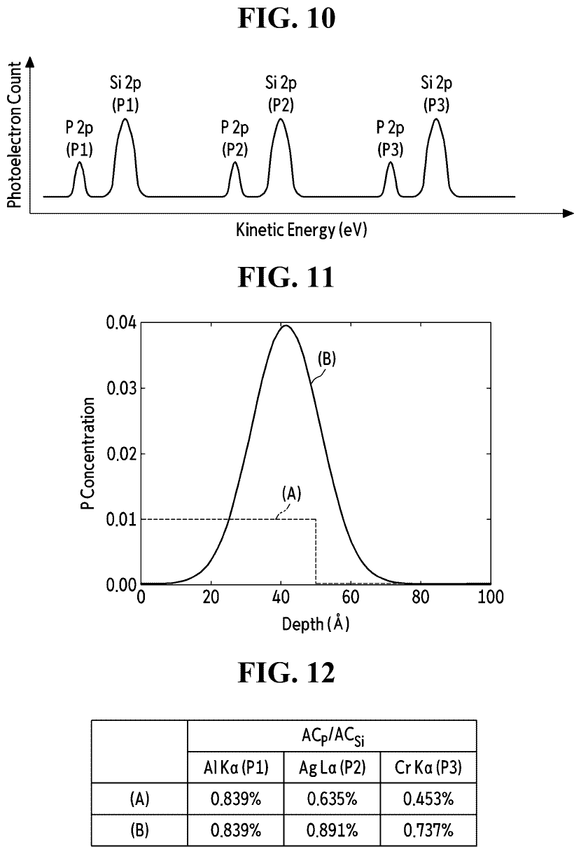

FIG. 8 is an exemplary flowchart illustrating step S200 of FIG. 2. FIGS. 9 and 10 are exemplary diagrams illustrating step S200 of FIG. 2.

Referring to FIGS. 1, 6, and 8, in step S210, multicolored X-rays 20 may be generated.

The electron beams 10 emitted from the filament 132 may collide with the metal patterns P1, P2, and P3 of the anode 134 to generate the multicolored X-rays 20. The multicolored X-rays 20 may include the X-rays generated from each of the metal patterns P1, P2, and P3.

In step S220, the multicolored X-rays 20 may be emitted onto the object 114.

The stage driving unit 116 may move the stage 110 so that the multicolored X-rays 20 may be emitted onto the object 114 under the control of the control unit 160.

In step S230, the peak area of each element for each of the metal patterns P1, P2, and P3 may be calculated (obtained).

For example, referring to FIG. 9, the object 114 may be a sample where silicon (Si) is doped in part with phosphorus (P). A first region R1 may be a Si region undoped with P, and a second region R2 may be a Si region doped with P. The object 114 will hereinafter be described as being a Si sample partially doped with P, the first metal pattern P1 as including Al, the second metal pattern P2 as including Ag, and the third metal pattern P3 as including Cr. An X-ray (Al Kα) may be generated from the first metal pattern P1, an X-ray (Ag Lα) may be generated from the second metal pattern P2, and an X-ray (Cr Kα) may be generated from the third metal pattern P3.

FIG. 10 shows the photoelectron spectrum emitted from the object 114 of FIG. 9 when the electron beams 10 are emitted onto each of the metal patterns P1, P2, and P3, where the X-axis represents the kinetic energy of photoelectrons 30 and the Y-axis represents the number of photoelectrons 30.

Referring to FIGS. 1, 6, 9, and 10, the detector 150 may detect the photoelectrons 30 emitted from each of the elements (i.e., Si and P) of the object 114 for each of the metal patterns P1, P2, and P3. The control unit 160 may analyze the photoelectrons 30 detected by the detector 150 to generate a photoelectron spectrum. The control unit 160 may calculate (obtain) the peak area of the photoelectrons 30 emitted from each of Si and P for each of the metal patterns P1, P2, and P3 from the photoelectron spectrum.

The concentration of a specific element in the vertical direction within the object 114 (i.e., the concentration profile of the specific element according to the vertical position within the object 114) may be calculated (obtained) through modeling (S240). The control unit 160 may calculate (obtain) the concentration of a specific element, for example, P, in the vertical direction within the object 114 using the peak areas of the photoelectrons 30 emitted from each of Si and P for each of the metal patterns P1, P2, and P3 calculated (obtained) from the photoelectron spectrum through modeling analysis.

In the photoelectron spectrum, a stronger peak is measured for elements with a higher relative concentration, and a weaker peak is measured for elements with a lower relative concentration. A first relative concentration AC_{P} of P is calculated (obtained) using Equation 1, and a second relative concentration AC_{Si} of Si is calculated (obtained) using Equation 2.

$$A {C}_{P} = \frac{\frac{{A}_{P 2 p}}{{ASF}_{P 2 p}}}{\frac{{A}_{Si 2 p}}{{ASF}_{Si 2 p}} + \frac{{A}_{P 2 p}}{{ASF}_{P 2 p}}} \qquad [ Equation 1 ]$$

$$A {C}_{Si} = \frac{\frac{{A}_{Si 2 p}}{{ASF}_{Si 2 p}}}{\frac{{A}_{Si 2 p}}{{ASF}_{Si 2 p}} + \frac{{A}_{P 2 p}}{{ASF}_{P 2 p}}} \qquad [ Equation 2 ]$$

Referring to Equations 1 and 2, “AC” denotes atomic concentration, the sum of the first and second relative atomic concentrations AC_{P} and AC_{Si} is 100%, “A” denotes each peak area in the photoelectron spectrum, and “ASF” denotes atomic sensitivity factor, which is a constant indicating how strongly each peak is measured in the photoelectron spectrum.

The control unit 160 may use Equations 1 and 2 to calculate (obtain) the first and second relative concentrations AC_{P} and AC_{Si} for each of the X-rays, for example, Al Kα, Ag Lα, and Cr Kα. The control unit 160 may input the first relative concentration AC_{P} relative to the second relative concentration AC_{Si} for each of Al Kα, Ag Lα, and Cr Kα into modeling to obtain the concentration profile of the specific element, for example, P, according to the vertical position within the object 114.

The modeling may output the concentration profile in the form of a Gaussian distribution using parameters such as mean, standard deviation, and area. The modeling may output the mean, standard deviation, and area using the first relative concentration AC_{P} relative to the second relative concentration AC_{Si} for each of Al Kα, Ag Lα, and Cr Kα. The modeling may receive the first relative concentration AC_{P} relative to the second relative concentration AC_{Si} for each of Al Kα, Ag Lα, and Cr Kα and output the concentration profile of P according to the vertical position within the object 114 in the form of a Gaussian distribution (e.g., graph (B) in FIG. 11).

The XPS apparatus according to one or more embodiments uses at least three X-rays, for example, Al Kα, Ag Lα, and Cr Kα, allowing the acquisition of at least three data for the first relative concentration AC_{P} relative to the second relative concentration AC_{Si}. Therefore, using modeling with three parameters (mean, standard deviation, and area), the concentration of P according to the vertical position within the object 114 can be calculated (obtained).

A method for calculating the concentration of a specific element in an object under inspection using XPS according to one or more embodiments may be performed through step S200, where the object 114 is measured.

FIGS. 11 through 13 are exemplary diagrams illustrating the modeling used in step S200 of FIG. 8.

FIG. 11 shows the concentration profile of P according to the vertical position within the object 114. Referring to FIG. 11, graph (A) represents the concentration profile of P according to the vertical position within the object 114 in the form of a Gaussian distribution, and graph (B) represents the concentration profile of P according to the vertical position within the object 114 in the form of a step distribution.

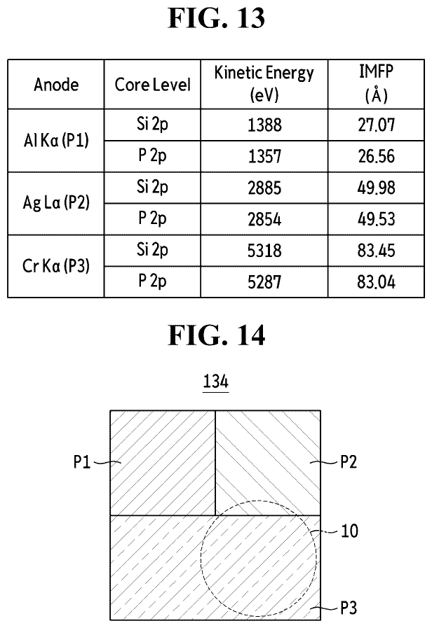

FIG. 12 shows the results of calculating (obtaining) the concentration of P according to the vertical position within the object 114 based on graphs (A) and (B) of FIG. 11. FIG. 13 shows exemplary values used in these calculations. For example, FIG. 13 shows Si core levels and their corresponding kinetic energies and inelastic mean free path (IMFP) values and P core levels and their corresponding kinetic energies and IMFP values when the X-rays (i.e., Al Kα, Ag Lα, and Cr Kα) generated from each of the metal patterns P1, P2, and P3 are emitted onto the object 114.

Graph (A) of FIG. 11 is the concentration profile of P in the object 114, uniformly doped with 1% P from a depth of 0 to 50 Å from its top surface.

XPS is a surface-sensitive measurement technique, and an intensity I(z) of the photoelectrons 30 emitted from the object 114 decreases away from the surface of the object 114. The intensity I(z) of the photoelectrons 30 according to a depth z in the object 114 is as indicated by Equation 3.

$$I ( z ) = I ( 0 ) {e}^{- z / EAL} \qquad [ Equation 3 ]$$

Referring to Equation 3, z denotes the depth from the top surface of the object 114, I(z) denotes the concentration of the specific element at the depth z, “EAL” denotes the effective attenuation length, which is the average distance that photoelectrons 30 travel within the object 114 without losing energy and corresponds to the IMFP in FIG. 13.

A case where the object 114 is doped with P according to the concentration profile of graph (A) of FIG. 11 will hereinafter be described as an example. In this case, a first value Al_{P}, which is the sum of relative P concentrations at the respective arbitrary depths z, and a second value Alₛᵢ, which is the sum of relative Si concentrations at the respective arbitrary depths z, when Al Kα is emitted onto the object 114, are calculated (obtained). The relative P concentrations and the relative Si concentrations at the respective arbitrary depths z may be calculated (obtained) using Equation 3. For example, when Al Kα is emitted onto the and the object 114, the relative concentration (I(10)) of P at a depth (z) of 10 Å is

$$0.01 {e}^{- \frac{10}{26.56}} ,$$

and the relative concentration (I(10)) of Si at the depth (z) of 10 Å is 1-0.01)

$${e}^{- \frac{10}{27.07}} .$$

Here, the first and second values Al_{P} and Alₛᵢ are integrated concentrations obtained by integrating the relative concentrations over the depth z.

The first and second relative concentrations AC_{P} and AC_{Si} are calculated (obtained) using Equations 4 and 5, respectively.

$$\frac{{Al}_{p}}{{Al}_{p} + {Al}_{Si}} \qquad [ Equation 4 ]$$

$$\frac{{Al}_{Si}}{{Al}_{P} + {Al}_{Si}} = A {C}_{Si} \qquad [ Equation 5 ]$$

The ratio of the first relative concentration AC_{P} to the second relative concentration AC_{Si} when using Al Kα is 0.839%.

Similarly, the first value Al_{P}, which is the sum of the relative concentrations (I(z)) of P at the respective arbitrary depths z, and the second value Al_{Si}, which is the sum of the relative concentrations (I(z)) of Si at the respective arbitrary depths z, when Ag La is emitted onto the object 114, are calculated (obtained) using Equation 3. Then, using Equations 4 and 5, the first and second relative concentrations AC_{P} and AC_{Si} when using Ag Lα are calculated (obtained). The ratio of the first relative concentration AC_{P} to the second relative concentration AC_{Si} when using Ag Lα is 0.635%. Similarly, the first value Al_{P}, which is the sum of the relative concentrations (I(z)) of P at the respective arbitrary depths z, and the second value Al_{Si}, which is the sum of the relative concentrations (I(z)) of Si at the respective arbitrary depths, when Cr Kα is emitted onto the object 114, are calculated (obtained) using Equation 3. Then, using Equations 4 and 5, the first and second relative concentrations AC_{P} and AC_{Si} when using Cr Kα are calculated (obtained). The ratio of the first relative concentration AC_{P} to the second relative concentration AC_{Si} when using Cr Kα is 0.453%.

The concentration profile of graph (B) of FIG. 11 corresponds to the concentration profile of P in the object 114, doped with P in a Gaussian distribution form from a depth of 0 to 100 Å from its top surface. The concentration profile of graph (B) has a mean of 41.4 Å, a standard deviation of 10 Å, and a profile area of 9.99.

According to the concentration profile of graph (B) of FIG. 11, the first value Al_{P}, which is the sum of the relative concentrations (I(z)) of P at the respective arbitrary depths z, and the second value Alₛᵢ, which is the sum of the relative concentrations (I(z)) of Si at the respective arbitrary depths z, when Al Kα is emitted onto the object 114, are calculated (obtained) using Equation 3. Then, using Equations 4 and 5, the first and second relative concentrations AC_{P} and AC_{Si} when using Al Kα are calculated (obtained). The ratio of the first relative concentration AC_{P} to the second relative concentration AC_{Si} when using Al Kα is 0.839%.

Similarly, the first value Al_{P}, which is the sum of the relative concentrations (I(z)) of P at the respective arbitrary depths z, and the second value Al_{Si}, which is the sum of the relative concentrations (I(z)) of Si at the respective arbitrary depths z, when Ag Lα is emitted onto the object 114, are calculated (obtained) using Equation 3. Then, using Equations 4 and 5, the first and second relative concentrations AC_{P} and AC_{Si} when using Ag Lα are calculated (obtained). The ratio of the first relative concentration AC_{P} to the second relative concentration AC_{Si} when using Ag Lα is 0.891%. Similarly, the first value Al_{P}, which is the sum of the relative concentrations (I(z)) of P at the respective arbitrary depths z, and the second value Alₛᵢ, which is the sum of the relative concentrations (I(z)) of Si at the respective arbitrary depths, when Cr Kα is emitted onto the object 114 are calculated (obtained) using Equation 3. Then, using Equations 4 and 5, the first and second relative concentrations AC_{P} and AC_{Si} when using Cr Kα are calculated (obtained). The ratio of the first relative concentration AC_{P} to the second relative concentration AC_{Si} when using Cr Kα is 0.737%.

Referring to FIGS. 11 and 12, when calculating the concentration of the object 114 in the vertical direction using Al Kα, it is not possible to distinguish between the concentration profile of graph (A) and the concentration profile of graph (B). However, when calculating the concentration of the object 114 in the vertical direction using Ag Lα and Cr Kα, it is possible to distinguish between the concentration profile of graph (A) and the concentration profile of graph (B). Therefore, the XPS apparatus according to one or more embodiments can accurately calculate (obtain) the concentration of the object 114 in the vertical direction.

The modeling may learn the first and second relative concentrations AC_{P} and AC_{Si} for each of Al Kα, Ag Lα, and Cr Kα in the case of the concentration profile of graph (B). The modeling may receive the first relative concentration AC_{P} and the second relative concentration AC_{Si} for each of Al Kα, Ag Lα, and Cr Kα and output the concentration profile. For example, the modeling may output the mean, standard deviation, and area of the Gaussian distribution from the first and second relative concentrations AC_{P} and AC_{Si} for each of Al Kα, Ag Lα, and Cr Kα.

The XPS apparatus according to one or more embodiments may generate the multicolored X-rays 20 by simultaneously emitting electron beams 10 on the metal patterns P1, P2, and P3 of the anode 134 and may calculate (obtain) the concentration of the object 114 in the vertical direction using the multicolored X-rays 20. In other words, it is possible to calculate (obtain) the concentration of the object 114 in the vertical direction through a single measurement. Therefore, the concentration of the object 114 in the vertical direction can be calculated (obtained) without the requirement of multiple measurements or destructive analysis of the object 114.

FIG. 14 is an exemplary diagram illustrating the anode of FIG. 1. For convenience of explanation, features that overlap with those described above with reference to FIGS. 1 through 13 will be briefly explained or omitted.

Referring to FIGS. 1 and 14, in the XPS apparatus according to one or more embodiments, the anode 134 may include three or more metal patterns P1, P2, and P3, and the electron beams 10 may be emitted onto at least two of the metal patterns P1, P2, and P3 of the anode 134, for example, the second and third metal patterns P2 and P3.

The control unit 160 may select an X-ray 20 for use in measuring the concentration of the specific element in the vertical direction of the object 114 based on the object 114 and modeling. The control unit 160 may control the X-ray source 120 to generate the selected X-rays 20. For example, the anode driving unit 136 may adjust the position of the anode 134 so that the electron beams 10 may be emitted onto some of the metal patterns P1, P2, and P3 under the control of the control unit 160.

For example, the control unit 160 may select the multicolored X-rays 20 generated from the second and second metal patterns P2 and P3 to measure the concentration of the specific element in the vertical direction of the object 114. The anode driving unit 136 may adjust the position of the anode 134 so that the electron beams 10 may be emitted onto the second and third metal patterns P2 and P3 under the control of the control unit 160.

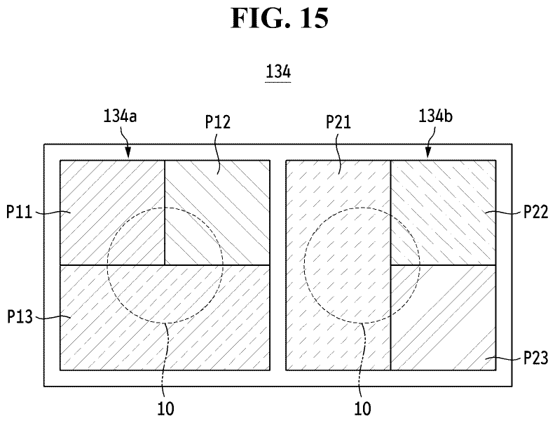

FIG. 15 is an exemplary diagram illustrating the anode of FIG. 1. For convenience of explanation, features that overlap with those described above with reference to FIGS. 1 through 13 will be briefly explained or omitted.

In another example, the multicolored X-rays 20, generated from the first through the third metal patterns P1, P2, and P3, may be emitted onto the object 114, and the control unit 160 may calculate (obtain) the concentration of the specific element in the vertical direction of the object 114 using data on photoelectrons detected by the detector 150, where the photoelectrons are generated by the X-rays from the second and third metal patterns P2 and P3 emitted onto the object 114.

Referring to FIGS. 1 and 15, in the XPS apparatus according to one or more embodiments, the anode 134 may include patterns, and each of the patterns may include metal patterns.

For example, the anode 134 may include a first pattern 134a and a second pattern 134b. The first pattern 134a may include metal patterns P11, P12, and P13, and the second pattern 134b may include metal patterns P21, P22, and P23. The number of patterns included in the anode 134 may vary.

The metal patterns P11, P12, and P13 included in the first pattern 134a and the metal patterns P21, P22, and P23 included in the second pattern 134b may include a metal material. The metal patterns P11, P12, and P13 included in the first pattern 134a and the metal patterns P21, P22, and P23 included in the second pattern 134b may have various shapes, and the relationship between the areas of the metal patterns P11, P12, and P13 included in the first pattern 134a or between the areas of the metal patterns P21, P22, and P23 included in the second pattern 134b may vary.

The control unit 160 may select the first or second pattern 134a or 134b of the anode 134 to measure the concentration of the specific element in the vertical direction of the object 114 based on the object 114 and modeling. Under the control of the control unit 160, the electron beams 10 may be emitted onto the first or second pattern 134a or 134b whenever measuring the concentration of the specific element in the vertical direction of the object 114. For example, the anode driving unit 136 may adjust the position of the anode 134 so that the electron beams 10 may be emitted onto the first or second pattern 134a or 134b under the control of the control unit 160.

While embodiments have been described with reference to the figures, it will be understood by those of ordinary skill in the art that various changes in form and details may be made therein without departing from the spirit and scope as defined by the following claims and their equivalents.

What is claimed is:

1. An X-ray photoelectron spectroscopy (XPS) apparatus comprising:
a filament configured to emit an electron beam;
an anode comprising metal patterns;
an anode actuator configured to move the anode;
a stage configured to support an object and a test pad;
a capillary configured to emit multicolored X-rays, generated by collision of the electron beam with the anode, onto the object or the test pad; and
a detector configured to detect photoelectrons emitted from the object or the test pad emitted by the multicolored X-rays.

2. The XPS apparatus of claim 1, wherein the multicolored X-rays comprise X-rays generated by the collision of the electron beam with each of the metal patterns, and
wherein the XPS apparatus further comprises one or more processors configured to control the anode actuator based on a number of photoelectrons emitted by each of the X-rays detected by the detector.

3. The XPS apparatus of claim 1, further comprising:
a stage actuator configured to move the stage, and
a capillary actuator configured to move the capillary.

4. The XPS apparatus of claim 3, further comprising:
one or more processors configured to control at least one of the anode actuator and the capillary actuator based on the photoelectrons detected by the detector corresponding to a position on the test pad.

5. The XPS apparatus of claim 1, wherein the metal patterns comprise different materials.

6. The XPS apparatus of claim 1, wherein the anode actuator is configured to move the anode such that the electron beam collides with all of the metal patterns.

7. The XPS apparatus of claim 1, wherein the anode actuator is configured to move the anode such that the electron beam collides with some of the metal patterns.

8. The XPS apparatus of claim 1, wherein the metal patterns comprise a first metal pattern comprising a first area and a second metal pattern comprising a second area different from the first area.

9. The XPS apparatus of claim 8, wherein the multicolored X-rays comprise a first X-ray generated by collision of the electron beam with the first metal pattern and a second X-ray generated by collision of the electron beam with the second metal pattern,
wherein the photoelectrons comprise first photoelectrons emitted from the object or the test pad emitted by the first X-ray and second photoelectrons emitted from the object or the test pad emitted by the second X-ray,
wherein the first area is larger than the second area, and
wherein a number of the first photoelectrons detected by the detector is less than a number of the second photoelectrons detected by the detector.

10. The XPS apparatus of claim 1, wherein the test pad comprises a metal.

11. An X-ray photoelectron spectroscopy (XPS) apparatus comprising:
an X-ray source configured to emit multicolored X-rays and comprising an anode that comprises metal patterns;
a stage configured to support an object;
a capillary configured to emit the multicolored X-rays onto the object;
a detector configured to detect photoelectrons emitted from the object emitted by the multicolored X-rays and generate data; and
one or more processors configured to obtain a concentration of an element in a vertical direction within the object based on at least part of the data.

12. The XPS apparatus of claim 11, wherein the X-ray source further comprises a filament configured to emit an electron beam, and
wherein the multicolored X-rays are generated by collision of the electron beam with at least two of the metal patterns.

13. The XPS apparatus of claim 11, further comprising:
a capillary actuator configured to adjust an angle at which the capillary is tilted relative to the stage, and
an anode actuator configured to adjust an angle at which the anode is tilted relative to the stage.

14. The XPS apparatus of claim 11, further comprising:
an anode actuator configured to move the anode;
a stage actuator configured to move the stage; and
a capillary actuator configured to move the capillary.

15. A method for calculating the concentration of an element included in an object under inspection using X-ray photoelectron spectroscopy (XPS), comprising:
generating X-rays with different energies;
emitting X-rays on the object;
detecting photoelectrons emitted from the object emitted by the X-rays; and
obtaining a concentration of the element in a vertical direction within the object based on the photoelectrons emitted by each of the X-rays.

16. The method of claim 15, wherein the generating the X-rays, comprises emitting an electron beam on an anode, the anode comprising metal patterns, and
wherein each of the X-rays is generated by collision of the electron beam with each of the metal patterns.

17. The method of claim 16, further comprising:
emitting the X-rays on a test pad;
detecting photoelectrons emitted from the test pad emitted by the X-rays; and
adjusting a position on the anode emitted by the electron beam based on the detected photoelectrons,
wherein the generating the X-rays, further comprises emitting the electron beam on the adjusted position on the anode.

18. The method of claim 16, further comprising:
emitting the X-rays on a test pad;
detecting photoelectrons emitted from the test pad emitted by the X-rays; and
adjusting an angle of the anode relative to the test pad based on the detected photoelectrons,
wherein the generating the X-rays, further comprises emitting the electron beam on the anode with the adjusted angle.

19. The method of claim 16, wherein the metal patterns comprise different materials.

20. The method of claim 15, further comprising:
emitting the X-rays on a test pad;
detecting photoelectrons emitted from the test pad emitted by the X-rays;
adjusting an angle at which the X-rays are incident on the test pad based on the detected photoelectrons; and
emitting the X-rays, at the adjusted angle, on the object.
